(19) United States
(12) Patent Application Publication
(10) Pub. No.: US 2022/0204266 A1
(43) Pub. Date: Jun. 30, 2022

(54) Systems And Methods To Dispense Items From A Vending Machine

(71) Applicant: Trinity Axis Inc., Schwenksville, PA (US)

(72) Inventors: David D. Davidar, Schwenksville, PA (US); Jeremiah Divyan David, Tamil Nadu (IN)

(73) Assignee: Trinity Axis Inc., Schwenksville, PA (US)

(21) Appl. No.: 17/138,640

(22) Filed: Dec. 30, 2020

(51) Int. Cl. B65G 1/08; B65G 1/137; B25J 9/02; B25J 9/10; B25J 15/00; G07F 11/62

(52) U.S. Cl. CPC B65G 1/08; B65G 1/137; G07F 11/62; B25J 9/104; B25J 15/0019; B25J 9/026

(57) ABSTRACT

Systems and methods of the present disclosure relate to dispensing techniques. A dispensing device comprises a first movable structure; a second movable structure; a member extending from the first movable structure to the second movable structure; an extendable component, wherein the extendable component is configured to extend upon movement of at least the first movable structure, the second movable structure, or the member, wherein an end of the member is adjacent to the extendable component; and wherein the dispensing device is configured to move along at least a first axis and a second axis of a system, wherein the dispensing device is configured to extend the extendable component along a third axis of the system.

### BACKGROUND

Vending machines may dispense a variety of items, including beverages, food, and other consumer products. Some vending machines may utilize rotating coils to dispense products stocked within the coils. These coils may be rotated by a motor, and during rotation of the coil, the products carried therein may be dispensed. The vending machines may be configured to accommodate specific product parameters, and vendors may spend a considerable amount of time stocking products within these coils.

For beverage container dispensing, vending machines may utilize rotating cradles that receive a beverage container. These cradles may also be sized for specific product parameters; vendors may employ a variety of shims, rods, sleeves, and other equipment to adjust vending geometry as desired. Requiring these additional components to accommodate different products may be undesirable, costly to manufacture, and increases overall assembly time. Additionally, some of these vending machines may employ overly complex cam mechanisms and switches that may fail overtime and require constant servicing or maintenance.

### SUMMARY

Disclosed herein are exemplary dispensing techniques. A dispensing device for a system may comprise: a first movable structure, a second movable structure, a member extending from the first movable structure to the second movable structure, and an extendable component. The extendable component may be configured to extend upon movement of at least the first movable structure, the second movable structure, or the member. An end of the member may be adjacent to the extendable component. The dispensing device may be configured to move along at least a first axis and a second axis of the system. The dispensing device may be configured to extend the extendable component along a third axis of the system.

Further disclosed herein is an exemplary system for dispensing items. The system may comprise: an arrangement of passages and a lateral rail extending laterally across an interior of the system. The lateral rail may be configured to move in a vertical direction adjacent to the passages. The system may further comprise a dispensing device disposed on the lateral rail. The dispensing device may be configured to move in a lateral direction within the interior of the system and configured to extend into a selected passage.

Further disclosed herein is an exemplary method for dispensing an item from a system. The method may comprise moving a dispensing device along a rail in a direction along a first axis of the system; moving a rail in a direction along a second axis of the system, wherein the rail extends laterally within the system; and extending a member, of the dispensing device, toward a front of the system in a direction along a third axis of the system, into a dispensing passage.

### BRIEF DESCRIPTION OF THE DRAWINGS

These drawings illustrate certain aspects of some examples of the present disclosure and should not be used to limit or define the disclosure.

FIG. 1 illustrates a vending machine, in accordance with examples of the present disclosure;

FIG. 2 illustrates an interior section of the vending machine, in accordance with examples of the present disclosure;

FIG. 3 illustrates a close-up perspective view of a dispensing device, in accordance with examples of the present disclosure;

FIG. 4 illustrates an interior cross-sectional view of a dispensing device, in accordance with examples of the present disclosure;

FIG. 5 illustrates extendable members in an extended configuration, in accordance with examples of the present disclosure;

FIG. 6 illustrates a perspective view of a dispensing device, in accordance with examples of the present disclosure;

FIG. 7 illustrates a grid of dispensing passages arranged within the interior section of the vending machine, in accordance with examples of the present disclosure; and

FIG. 8 illustrates an operative sequence for dispensing an item from a vending machine, in accordance with examples of the present disclosure.

### DETAILED DESCRIPTION

It is to be understood that the present disclosure is not limited to particular devices or methods, which may, of course, vary. It is also to be understood that the terminology used herein is for the purpose of describing particular embodiments only and is not intended to be limiting. All numbers and ranges disclosed herein may vary by some amount. Whenever a numerical range with a lower limit and an upper limit is disclosed, any number and any included range falling within the range are specifically disclosed. Although individual embodiments are discussed herein, the invention covers all combinations of all those embodiments. As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. If there is any conflict in the usages of a word or term in this specification and one or more patent or other documents that may be incorporated herein by reference, the definitions that are consistent with this specification should be adopted for the purposes of understanding this invention.

The present disclosure generally relates to techniques for dispensing items from a vending machine. Specifically, example embodiments of the systems and methods of the present disclosure may utilize at least three axes to allow movement for a dispensing device. The multiple axes may include at least an x-axis, a y-axis, and a z-axis that may allow for precise and quick dispensing of items that are stocked in the vending machine.

Further, employment of at least three axes may allow for unobstructed stocking of products in the vending machine without interference from surrounding components, such as the coils or the cradles, for example. Additionally, the utilization of the axes may require fewer components (e.g., the coils or cradles) than typical vending machines, resulting in fewer malfunctions such as an item not being dispensed after being purchased.

In particular examples, a wide variety of items such as consumer products may be arranged or stocked in an array of dispensing passages arranged in a grid of rows and/or columns within an interior section of the vending machine. The dispensing passages may be horizontal and may extend from a rear of the vending machine to a front of the vending machine. In some examples, the dispensing device may be configured to move along a rear interior section of the vending machine with access to products disposed or stacked within each dispensing passage of the grid. The dispensing passages may be disposed in front of the dispensing device and may be configured to receive an extendable member of the dispensing device. For example, after purchasing of a product, the dispensing device may move to align with a particular dispensing passage to dispense the product.

The dispensing device may be configured to move laterally and vertically within the interior section of the vending machine. In particular examples, the dispensing device may be configured to move via rails. A lateral rail may be movably coupled to a vertical rail which may remain fixed or stationary within the vending machine. The lateral rail may move vertically along the vertical rail, and the dispensing device may be movably disposed on the lateral rail, such that the dispensing device may move laterally along the lateral rail. Non-limiting configurations of the rails may include linear tracks with rollers, or a conveyor system. The rails may allow lateral alignment (e.g., x-axis) and vertical alignment (e.g., y-axis) of the dispensing device with each of the dispensing passages and products therein, while the dispensing device is configured to push the products along a z-axis which may extend longitudinally through each of the dispensing passages, such that the products fall from the dispensing passages into a retrieval bin that may be positioned at a bottom portion of the vending machine for access by a consumer.

In some examples, the vending machine may include a housing and an arrangement of the dispensing passages disposed within the housing. The lateral rail may extend laterally across the housing. The lateral rail may be configured to move in the vertical direction adjacent to the passages such as behind the passages, for example. The dispensing device may be disposed on the lateral rail and may be configured to move in a lateral direction and extend at least one member into a passage.

The dispensing device may include at least one extendable member that may extend and retract in a direction along a z-axis. In particular examples, the dispensing device may include telescoping members. The telescopic members may be concentrically disposed within one another and may be driven by an electric motor operatively coupled to a drive mechanism. A non-limiting example of the drive mechanism may include a chain and a sprocket, however, other suitable mechanisms may be utilized for extension and retraction of a dispensing member, as should be understood by one having skill in the art, with the benefit of this disclosure.

In some examples, the dispensing device may include a housing. A first movable structure and a second movable structure may be disposed within the housing. A member may extend from the first movable structure to the second movable structure. An extendable component may be disposed within the housing, and the extendable component may be configured to extend from the housing upon movement of at least the first movable structure, the second movable structure, or the member. An end of the member may be adjacent to the extendable component, and the dispensing device may be configured to move along an x-axis and a y-axis of a vending machine. The dispensing device may be configured to extend the extendable component along a z-axis of the vending machine.

An exemplary operative sequence for dispensing an item from the vending machine may include moving the lateral rail in a direction along the y-axis of the vending machine. The dispensing device may also move along the lateral rail in a direction along the x-axis of the vending machine. After movement in the x and y directions, the dispensing device may extend at least one member in a direction along a z-axis of the vending machine, into a dispensing passage to dispense an item.

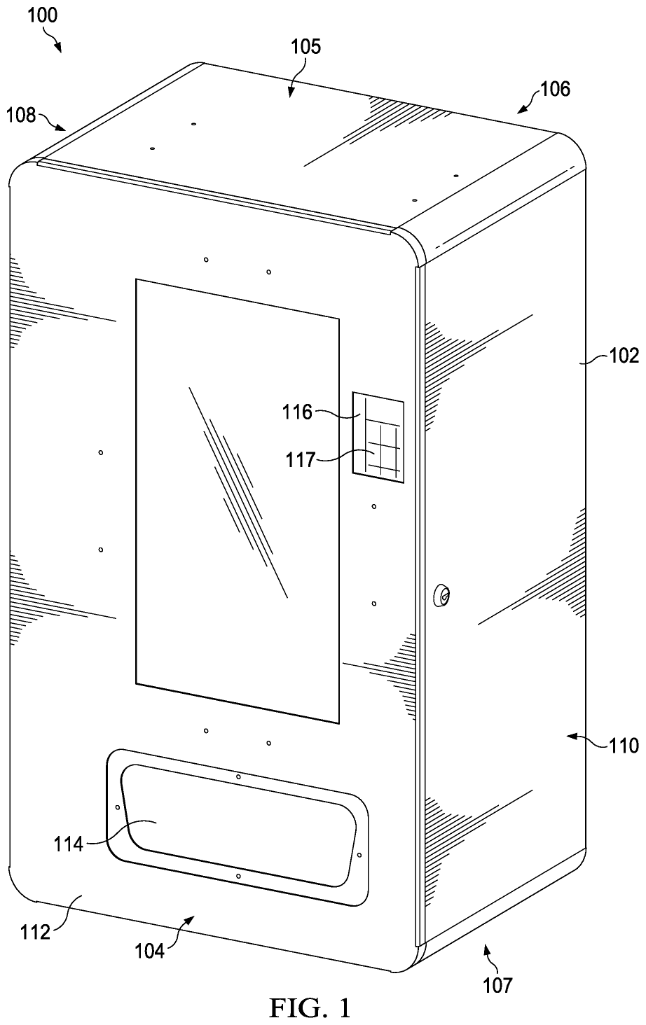

FIG. 1 illustrates a vending machine 100, in accordance with examples of the present disclosure. The vending machine 100 may include a housing 102 that houses internal components (not shown) of the vending machine 100. As illustrated, the vending machine 100 may include a front side 104, a top side 105, a rear side 106, a bottom side 107, a left lateral side 108, and a right lateral side 110. The front side 104 may include a removable panel or door 112 (e.g., a hinged door or sliding door) which may be opened to allow access to an interior of the vending machine 100 for servicing or stocking of consumer products, for example. The door 112 may include a gate 114 for access to purchased products that have fallen in a retrieval bin that is positioned behind the gate 114. In some examples, the gate 114 may be optional to allow open access to purchased products in the retrieval bin. In some examples, the vending machine 100 may also include a system controller 116 configured to operate the vending machine 100. In some examples, the system controller 116 may include a payment interface or validation interface.

The system controller 116 may include a display, a storage unit, and/or any instrumentality or aggregate of instrumentalities operable to compute, estimate, classify, process, transmit, receive, retrieve, originate, switch, store, display, manifest, detect, record, reproduce, handle, validate, or utilize any form of information, intelligence, or data for business, scientific, control, or other purposes. For example, the system controller 116 may be a computer, a network storage device, RFID scanner, NFC reader, validation device or any other suitable device and may vary in size, shape, performance, functionality, and price. The system controller 116 may include a processing unit (e.g., microprocessor, central processing unit, programmable logic controller (PLC), etc.) that may process data by executing software or instructions obtained from a local non-transitory computer readable media (e.g., optical disks, magnetic disks). The non-transitory computer readable media may store software or instructions of the methods described herein. Non-transitory computer readable media may include any instrumentality or aggregation of instrumentalities that may retain data and/or instructions for a period of time. The non-transitory computer readable media may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

The system controller 116 may also include input device(s) (e.g., keyboard, mouse, touchpad, scanners, RFID readers, card readers, NFC readers, data reader devices, etc.) and output device(s) (e.g., monitor, printer, secondary display unit 117, etc.). The input device(s) and output device(s) provide a user interface. For example, the system controller 116 may enable an operator to select and perform analysis, view collected data, view analysis results, and/or perform other tasks.

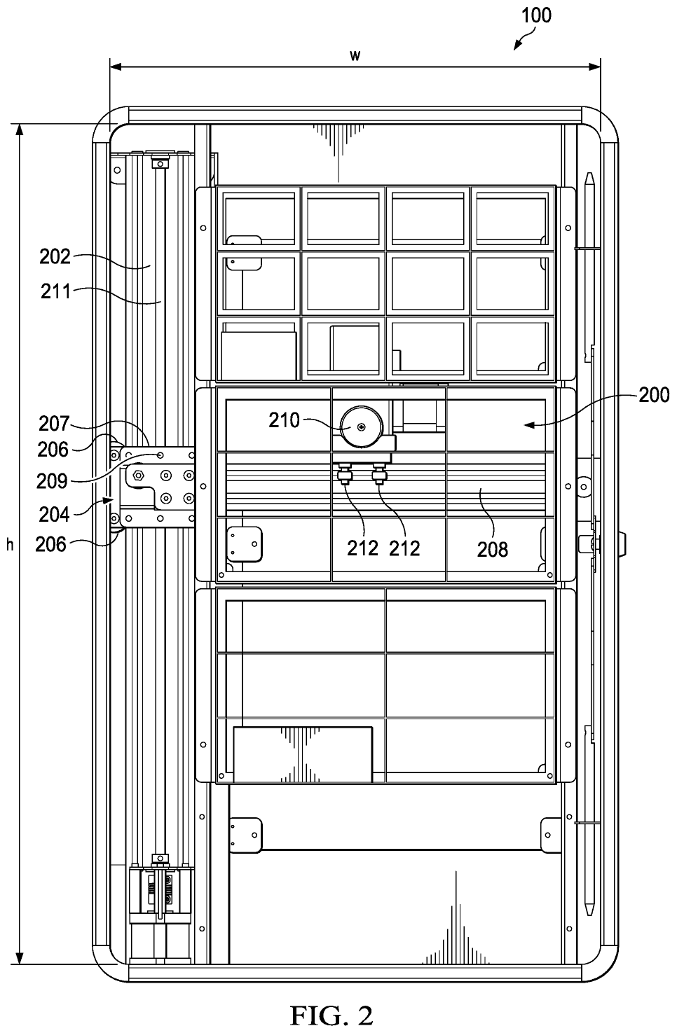

FIG. 2 illustrates a rear view of an interior section 200 of the vending machine 100, in accordance with examples of the present disclosure. The interior section 200 may include a vertical rail 202 extending along a height h of a rear of the interior section 200 of the vending machine 100. The vertical rail 202 may be coupled or fixed to the interior section 200 with any suitable technique and may remain stationary. Suitable techniques for coupling of fixing the vertical rail 202 to the interior section 200 may include, but are not limited to, bolts, threads, or welds, for example.

In some examples, a movable structure 204 may include at least two rollers 206 and/or a nut block 207, each movably disposed on the vertical rail 202. In some examples, the nut block 207 may include a structure configured to move along the vertical rail 202 via a lead member 209 (e.g., a screw) that may extend into the rail 202 such as within a slot 211. The nut block 207 may move along the vertical rail 202 by any suitable means such as conveyor system and/or gears disposed within (or adjacent to) the vertical rail 202. In some examples, the vertical rail 202 may be configured as a linear track allowing the movable structure 204 to move vertically along the vertical rail 202. Other suitable techniques for facilitating movement of the moveable structure 204 on vertical rail 202 may be used.

A lateral rail 208 may extend from the movable structure 204. The lateral rail 208 may extend laterally across a width w of the interior section 200 of the vending machine 100, in some examples. The lateral rail 208 may move vertically along the vertical rail 202 via the movable structure 204. It should be noted that other suitable mechanisms may be utilized for vertical movement within the interior section 200 of the vending machine 100, as should be understood by one having skill in the art with the benefit of this disclosure.

A dispensing device 210 may be movably disposed on the lateral rail 208. The dispensing device 210 may include rollers 212 that may contact the lateral rail 208. The dispensing device 210 may be configured to move laterally along the lateral rail 208.

The rollers 212 may be any suitable rollers for facilitating movement of the dispensing device 210 along the lateral rail 208. For example, the rollers 212 may be moved along the lateral rail 208 by a belt and pulley mechanism, and the lateral rail 208 may be configured as a linear track allowing the dispensing device 210 to move laterally along the lateral rail 208. It should be noted that other suitable mechanisms may be utilized for lateral movement within the interior section 200 of the vending machine 100, as should be understood by one having skill in the art with the benefit of this disclosure.

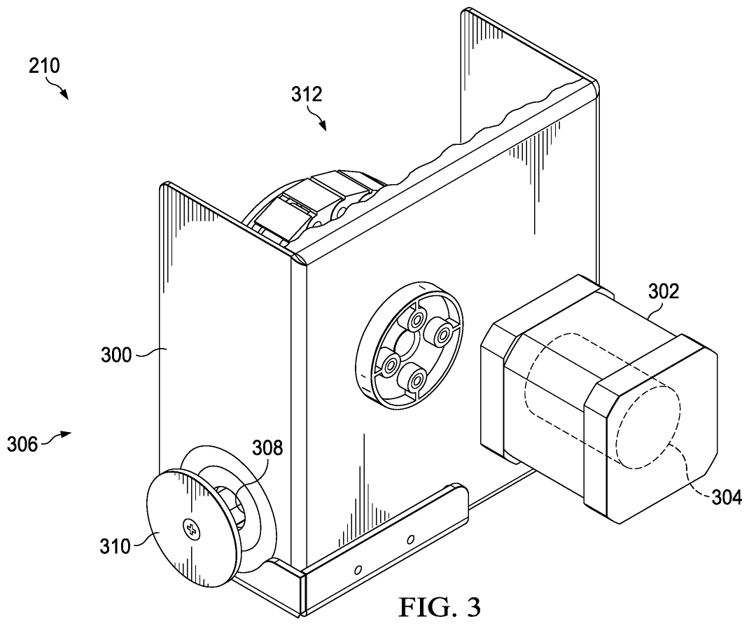

FIG. 3 illustrates a close-up perspective view of the dispensing device 210, in accordance with examples of the present disclosure. The dispensing device 210 may include a housing 300. The housing 300 may be of any suitable shape such as rectangular, for example. A second housing 302 may be disposed adjacent to the housing 300. The second housing may also be of any suitable shape such as a rectangle, for example. The second housing 302 may contain an electric motor 304 which may be powered by any suitable means such as wires and an electric grid or a battery, for example.

An interior of the housing 300 may be in fluid communication with an interior of the second housing 302 to allow operation of the motor 304, for example. A front portion 306 of the housing 300 may include an aperture 308 which may allow at least one extendable member 310 to extend away from the housing 300. The member 310 may extend from an interior portion 312 of the housing 300 during dispensing of an item, or the member 310 may retract into the interior portion 312 after the dispensing.

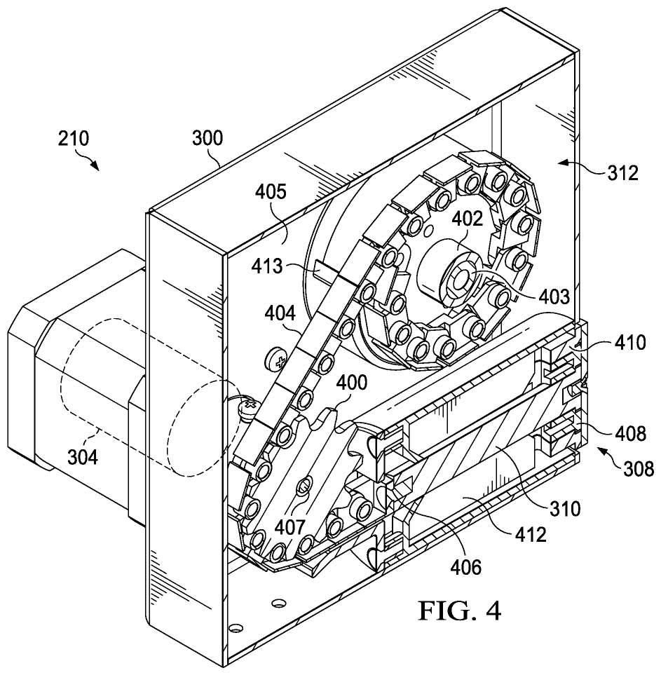

FIG. 4 illustrates the interior portion 312 of the housing 300 of the dispensing device 210, in accordance with examples of the present disclosure. As illustrated, the housing 300 may contain a movable member (e.g., a sprocket 400), a spool 402, and member 404 (e.g., a chain). The motor 304 may be operatively coupled (e.g., via a shaft or direct coupling) to the movable member such as a sprocket 400 that may be rotatably disposed within the interior portion 312. The sprocket 400 may be adjacent to the spool 402. In some examples, the spool 402 may be configured to rotate. The sprocket 400 and the spool 402 may each be rotatably coupled to an inner surface of the interior portion 312. The sprocket 400, spool 402 and member 404 may be configured as a linear actuator. The spool 402 may rotate back to the coiled position by the assistance of a spring 413 that may be disposed adjacent to the spool 402 such as between an inner wall 405 of the housing 300 and the spool 402, for example. It should be noted that this configuration is a non-limiting example and other suitable linear actuators may be utilized for conversion of rotational movement of the motor 304 to linear movement, as should be understood by one having skill in the art with the benefit of this disclosure.

For example, a pin 403 may rotatably couple the spool 402 to the inner wall 405; and a shaft 407 may extend from the sprocket 400 through the inner wall 405 and to the motor 304. A member 404 may extend from the spool 402 to the sprocket 400 and may operatively couple the sprocket 400 to the spool 402. The member 404 may be configured to transfer rotational movement of the sprocket 400 to the extendable member 310. In some examples, the member 404 may include a chain that may be at least partially wound around the spool 402 and the sprocket 400. A distal end 406 of the member 404 may be coupled to at least one extendable member 310 configured to pass through the aperture 308. While member 404 is illustrated on FIG. 4 as a chain, other suitable devices may be used for transferring motion of the sprocket 400 to the extendable member 310, including, but not limited to, a belt.

In some examples, a plurality of extendable members may be disposed concentrically within the interior portion 312 of the dispensing device 210. For example, the extendable member 310 may be disposed within extendable members 408 and 410. The extendable members 310, 408, and 410 may be disposed within a base 412 in a telescopic or concentric configuration. In other examples, the extendable members 310, 408, and 410 may be aligned eccentrically. The base 412 may be coupled to the interior portion 312 of the housing 300, such as to the inner wall 405, for example. The base 412 may be coupled to the interior portion 312 of the housing 300 via any suitable means such as fasteners including threads, welds, or pins, for example. As illustrated, the extendable members 310, 408, and 410 are in a retracted configuration; during dispensing, the extendable members 310, 408, and 410 may extend in a telescopic fashion, for example. It should be noted that the telescopic configuration is a non-limiting example and that other suitable techniques for extension may be utilized, as should be understood by one having skill in the art, with the benefit of this disclosure. Examples of other techniques that could be used instead of telescopic members may include rack & pinion technique.

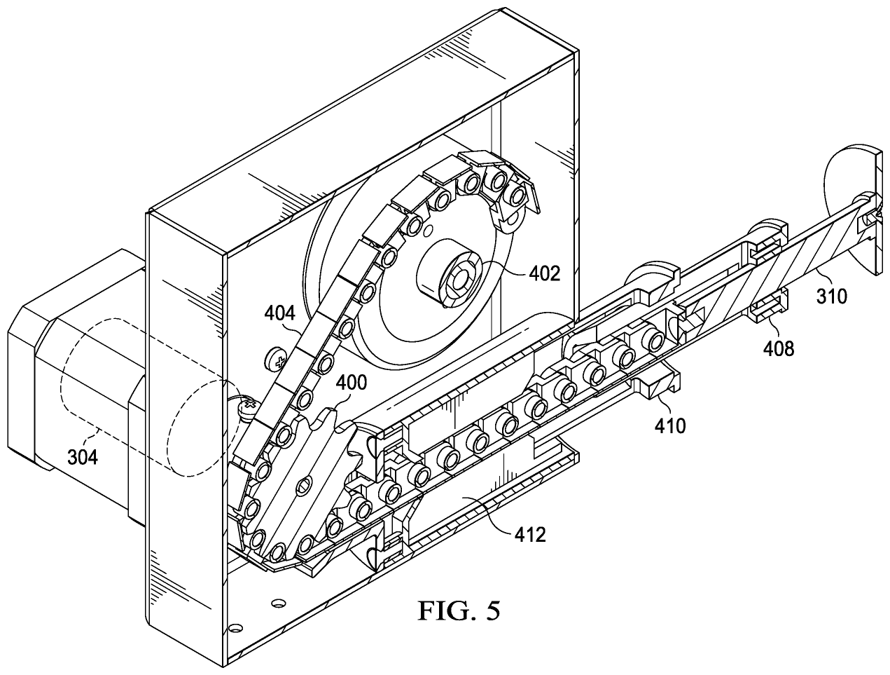

FIG. 5 illustrates the extendable members 310, 408, and 410 in an extended configuration, in accordance with examples of the present disclosure. The extendable members 310, 408, and 410 may extend from the base 412 upon rotation of sprocket 400 by the motor 304. The rotation of the sprocket 400 may cause rotation of the spool 402 thereby causing at least partial unravelling of the member 404 from around the spool 402, thereby causing extension of the extendable members 310, 408, and 410. In some examples, the extendable members 310, 408, and 410 may extend from the base 412 telescopically, as shown. Each of the extendable members 310, 408, 410, and the base 412 may have outer diameters (OD) and inner diameters (ID) that are configured to allow retraction and extension in a telescopic fashion.

For example, an OD of the member 310 may be less than an ID of the member 408; an OD of the member 408 may be less than an ID of the member 410; and an OD of the member 410 may be less than an ID of the base 412. Each of the extendable members 310, 408, 410, and the base 412 may be hollow to allow for passage of the member 404 therethrough during extension and retraction. In some examples, the extendable members 310, 408, 410, and the base 412 may be tubular, however, any suitable shape may be utilized as should be understood by one having skill in the art with the benefit of this disclosure.

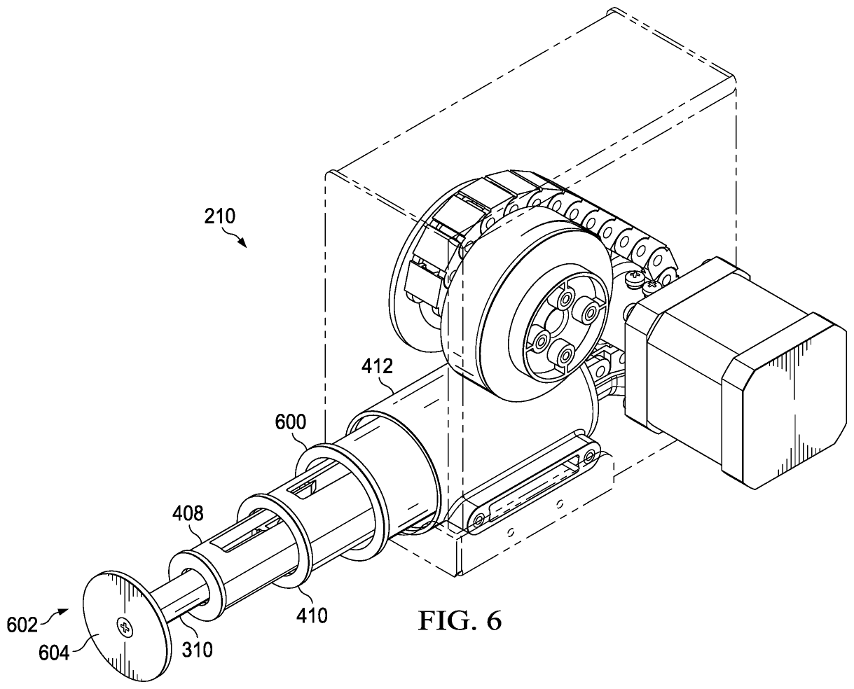

FIG. 6 illustrates a perspective view of the dispensing device 210, in accordance with examples of the present disclosure. In some examples, the dispensing device 210 may include the extendable members 310, 408, 410, and an additional extendable member 600 that may extend from the base 412 in a telescopic or concentric configuration. The extendable members 310, 408, 410, and 600 may be hollow to allow for passage of the member 404, as shown on FIG. 5.

In certain examples, the extendable member 310 may include a distal end 602 with a flat surface 604 to facilitate contacting and pushing items forward. It should be noted that the shapes and sizes for the extendable members 310, 408, 410, and 600 may be of any suitable shape. For example, the extendable members 310, 408, 410, and 600 may be of a cylindrical, box-type, prism, or rectangular shape.

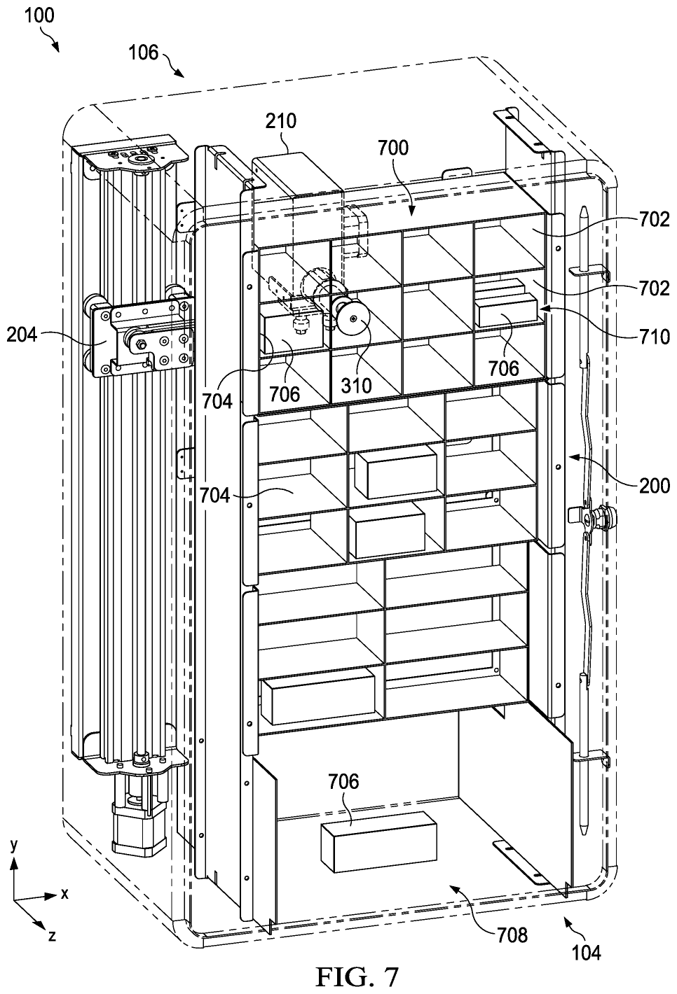

FIG. 7 illustrates a grid 700 of dispensing passages 702 arranged within the interior section 200 of the vending machine 100, in accordance with examples of the present disclosure. The dispensing passages 702 may include through-holes 704 extending horizontally from the rear side 106 of the vending machine 100 to the front side 104 of the vending machine 100. An item 706 such as a consumer product may be stocked or stacked within a dispensing passage 702. During dispensing, the movable structure 204 and the dispensing device 210 may move to align with the item 706 along the x-axis and the y-axis. Upon alignment, the dispensing device 210 may extend at least the extendable member 310 along the z-axis to push the item 706 such that the item 706 falls into a retrieval bin 708 for retrieval by a consumer. In some examples, a horizontal stack 710 of items 706 may be disposed within each dispensing passage 702. As items are dispensed, the horizontal stack 710 becomes shorter. In certain examples, the display unit 117 may include a touch screen display that may include a user interface to select or have access to the locations of items 706. In some examples, the system controller 116 may store a map or have access to the locations of the items 706.

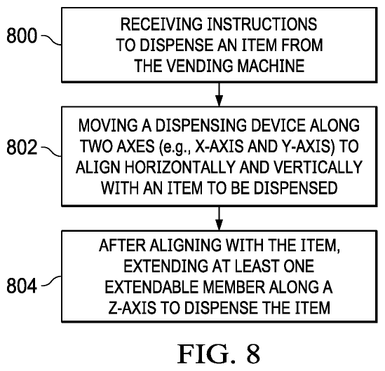

FIG. 8 illustrates a sequence for dispensing an item from a vending machine, in accordance with particular examples of the present disclosure. At step 800, the system controller 116 (e.g., the touch screen display) may receive instructions to dispense an item 706 from the vending machine 100, as shown on FIGS. 1 and 7, for example. At step 802, the dispensing device 210 may move along two axes (e.g., x-axis and y-axis) to align horizontally and vertically with an item 706 in a dispensing passage 702, as shown on FIGS. 2 and 7, for example. At step 804, after aligning with the item 706, the dispensing device 210 may extend at least one extendable member 310 along a z-axis to push the item 706 into the retrieval bin 708, as shown on FIG. 7, for example. After dispensing the item 706, the dispensing device 210 may retract the extendable member 310, as shown on FIG. 4, for example.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

What is claimed is:

1. A dispensing device for a system, the dispensing device comprising:
a first movable structure;
a second movable structure;
a member extending from the first movable structure to the second movable structure;
an extendable component, wherein the extendable component is configured to extend upon movement of at least the first movable structure, the second movable structure, or the member, wherein an end of the member is adjacent to the extendable component; and
wherein the dispensing device is configured to move along at least a first axis and a second axis of the system, wherein the dispensing device is configured to extend the extendable component along a third axis of the system.

2. The dispensing device of claim 1, further comprising a housing, wherein the first moveable structure, the second moveable structure, and the extendable component are disposed within the housing, and wherein the extendable component is configured to extend from the housing upon the movement of the at least the first movable structure, the second movable structure, or the member.

3. The dispensing device of claim 1, wherein the first movable structure is rotatably attached to an interior portion of the dispensing device.

4. The dispensing device of claim 3, wherein the second movable structure is rotatably attached to an interior portion of the dispensing device.

5. The dispensing device of claim 1, wherein the first movable structure is adjacent to the second movable structure.

6. The dispensing device of claim 5, wherein each of the first and second movable structures comprises a spool or a sprocket.

7. The dispensing device of claim 6, wherein the member comprises a chain coupling the first movable structure with the second movable structure.

8. The dispensing device of claim 1, further comprising a motor that is coupled to the first movable structure or the second movable structure.

9. The dispensing device of claim 1, wherein the extendable component is telescopic.

10. The dispensing device of claim 1, wherein the system is a vending machine.

11. The dispensing device of claim 1:
wherein the dispensing device further comprises a housing;
wherein the axes comprise an x-axis, a y-axis, and a z-axis;
wherein the dispensing device further comprises a motor that is coupled to the first movable structure;
to cause rotation of the first moveable structure upon operation of the motor;
wherein the first moveable structure comprises a sprocket that is rotatably coupled to an interior portion of the housing;
wherein the second moveable structure comprises a spool that is rotatably coupled to an interior portion of the housing;
wherein the member comprises a chain that is partially spooled on the spool, such that rotation of the sprocket in a first direction unspools the chain from the spool and rotation of the sprocket in an opposite direction spools the chain on the spool; and
wherein the extendable component is telescopic.

12. A system comprising:
an arrangement of passages;
a lateral rail extending laterally across an interior of the system, the lateral rail configured to move in a vertical direction adjacent to the passages; and
a dispensing device disposed on the lateral rail, the dispensing device configured to move in a lateral direction within the interior of the system and configured to extend into a selected passage.

13. The system of claim 12, wherein the passages are disposed in front of the dispensing device.

14. The system of claim 12, wherein the system further comprises a vending machine, wherein the arrangement of passages comprises at least one consumer product in the vending machine.

15. The system of claim 12, wherein the passages each extend horizontally from a rear of the system to a front of the system.

16. The system of claim 12, further comprising a vertical rail coupled to an interior of the system, wherein the lateral rail is movably attached to the vertical rail, wherein the dispensing device is configured to move vertically along the vertical rail.

17. The system of claim 14, wherein the dispensing device comprises at least one extendable member configured to extend into the selected passage of the passages.

18. A method for dispensing an item from a system, the method comprising:
moving a dispensing device along a rail in a direction along a first axis of the system;
moving the rail in a direction along a second axis of the system, wherein the rail extends laterally within the system; and
extending a member, of the dispensing device, toward a front of the system in a direction along a third axis of the system, into a dispensing passage.

19. The method of claim 18, further comprising pushing an item from the dispensing passage upon extension of the member, the item comprising a consumer product in a vending machine.

20. The method of claim 19, further comprising retracting the member upon dispensing of the item from the vending machine.

21. The method of claim 20, further comprising rotating a structure within the system to extend or retract the member.

22. The method of claim 21, further comprising moving a chain to extend or retract the member, wherein the chain contacts the structure that rotates.
